(19) United States
(12) Patent Application Publication
(10) Pub. No.: US 2026/0037820 A1
(43) Pub. Date: Feb. 5, 2026

(54) DEVICE AND METHOD FOR SELECTING TRAINING DATA FOR 3D OBJECT RECOGNITION

(71) Applicant: HYUNDAI MOBIS CO., LTD., Seoul (KR)

(72) Inventors: Gyu Seok OH, Yongin-si (KR); Hyun Wook JEONG, Yongin-si (KR)

(73) Assignee: HYUNDAI MOBIS CO., LTD., Seoul (KR)

(21) Appl. No.: 19/082,883

(22) Filed: Mar. 18, 2025

(30) Foreign Application Priority Data
Jul. 31, 2024 (KR) 10-2024-0101758

(51) Int. Cl. G06N 3/091

(52) U.S. Cl. CPC G06N 3/091

(57) ABSTRACT

Provided is a device for selecting training data for 3D object recognition, which includes a first processor configured to select initial training data based on diversity from an original dataset, a second processor configured to select training data based on informativeness from the initial training data selected by the first processor, and a third processor configured to calculate diversity relationships among the training data selected by the second processor and to select final training data.

### CROSS-REFERENCE TO RELATED APPLICATION

This application claims priority from and the benefit of Korean Patent Application No. 10-2024-0101758, filed on Jul. 31, 2024, which is hereby incorporated by reference for all purposes as if set forth herein.

### BACKGROUND

### Field

Exemplary embodiments according to the present disclosure relate to a device and method for selecting training data for 3D object recognition, enabling the selection of training data to achieve optimal learning performance for 3D object recognition with a minimal amount of training data.

### Discussion of the Background

It is essential to secure a large amount of high-quality training data to enable operation.

Therefore, ensuring good deep learning performance inevitably requires high labeling costs during the training process. One approach to addressing the issue of labeling costs is active learning.

Active learning is a learning method that uses a trained neural network model to select effective data for training from an unlabeled dataset and utilize this data for training. The goal of active learning is to achieve optimal performance of the target model using only a portion of the training data.

Active learning may consider informativeness and diversity to select effective data for training.

In this case, informativeness may be measured using entropy and inconsistency. For example, if the entropy of the data is high, this may indicate that the data has high informativeness. In addition, if there is a large difference in the inference results between the original and augmented data, this may indicate high inconsistency, and consequently, the data may also indicate high informativeness.

Conventionally, data is selected either by considering informativeness or by considering diversity. However, a method that selects data based solely on informativeness, without considering the diversity of data, tends to select a large number of data concentrated in one region of the feature space. In addition, a method that selects data based solely on diversity, without considering informativeness, may result in selecting a large number of data that are not useful (valid) for improving the performance of the deep learning model.

Research has been conducted on data selection methods for active learning, but existing active learning algorithms still have the issue of low usefulness (validity). Therefore, a method is required that considers both informativeness and diversity in selecting training data while improving usefulness (validity) thereof.

The related art of the present disclosure is disclosed in Korean Patent Application Publication No. 10-2023-0032459 (published on Mar. 7, 2023).

### SUMMARY

Various embodiments of the present disclosure relate to a device and method for selecting training data for 3D object recognition, enabling the selection of training data to achieve optimal learning performance for 3D object recognition with a minimal amount of training data.

A device for selecting training data for 3D object recognition according to an aspect of the present disclosure includes a first processor configured to select initial training data based on diversity from an original dataset, a second processor configured to select training data based on informativeness from the initial training data selected by the first processor, and a third processor configured to calculate diversity relationships among the training data selected by the second processor and to select final training data.

In an embodiment, the first to third processors enable integration into a single processor.

In an embodiment, the first processor selects representative data for each cluster based on a K-means clustering algorithm to generate an initial training dataset.

In an embodiment, the second processor iterates a process of performing primary data selection from the initial training data, followed by secondary data selection, a specified number of times.

In an embodiment, the second processor performs the primary data selection using an algorithm that calculates uncertainty of the data based on entropy and performs the secondary data selection using an algorithm that calculates inconsistency of the data.

In an embodiment, the second processor generates augmented data by horizontally flipping original data when selecting secondary training data and selects data with high entropy from the augmented data.

In an embodiment, the second processor quantifies uncertainty of data when selecting primary and secondary training data, sorts the data in descending order, and selects highly ranked data with high quantified values.

In an embodiment, the third processor calculates similarities between secondary training data, excludes data with a similarity higher than a threshold, and selects only data with low similarity as the final training data.

In an embodiment, the third processor calculates the similarity between data using a Euclidean distance algorithm and selects only data with a calculated distance greater than a threshold as the final data.

A method for selecting training data for 3D object recognition according to another aspect of the present disclosure includes selecting initial training data, by a first processor, based on diversity from an original dataset, selecting training data, by a second processor, based on informativeness from the initial training data selected by the first processor, and calculating diversity relationships, by a third processor, among the training data selected by the second processor and selecting final training data.

In the embodiment, it is possible to select training data to achieve optimal learning performance for 3D object recognition with a minimal amount of training data.

In the embodiment, it is possible to select training data by considering both informativeness and diversity, thereby achieving optimal learning performance for 3D object recognition with a minimal amount of training data.

In the embodiment, it is possible to achieve optimal learning performance with a small amount of data, thereby reducing data processing costs.

In the embodiment, by considering both informativeness and diversity of data in data selection, the advantages of each metric are maximized through the interaction between informativeness and diversity.

In the embodiment, it is possible to select datasets collected in environments different from that of the existing dataset by considering the diversity between the existing labeled dataset and the newly selected dataset.

### BRIEF DESCRIPTION OF THE DRAWINGS

FIG. 1 is an exemplary diagram illustrating a schematic configuration of a device for selecting training data for 3D object recognition according to an embodiment of the present disclosure.

FIG. 2A-FIG. 2D are exemplary diagrams illustrating a method for sequential selection of a dataset by a first to third processors in FIG. 1.

FIG. 3 is an exemplary diagram illustrating an operation of selecting initial training data by the first processor in FIG. 2A-FIG. 2D.

FIG. 4 is an exemplary diagram illustrating an operation of selecting primary training data by the second processor in FIG. 2A-FIG. 2D.

FIG. 5 is an exemplary diagram illustrating an operation of selecting secondary training data by the second processor in FIG. 2A-FIG. 2D.

FIG. 6 is an exemplary diagram illustrating an operation of selecting final training data by the third processor in FIG. 2A-FIG. 2D.

FIG. 7 is an exemplary diagram illustrating an algorithm for calculating the similarity between newly selected data and previously selected data in FIG. 6.

### DETAILED DESCRIPTION OF THE ILLUSTRATED EMBODIMENTS

An embodiment of a device and method for selecting training data for 3D object recognition according to the present disclosure will be described hereinafter with reference to the accompanying drawings.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

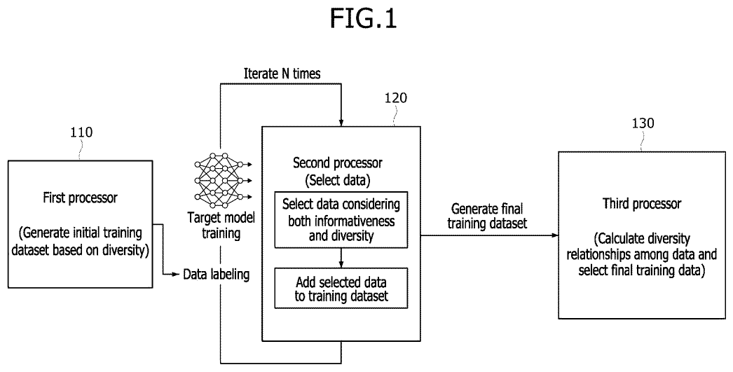

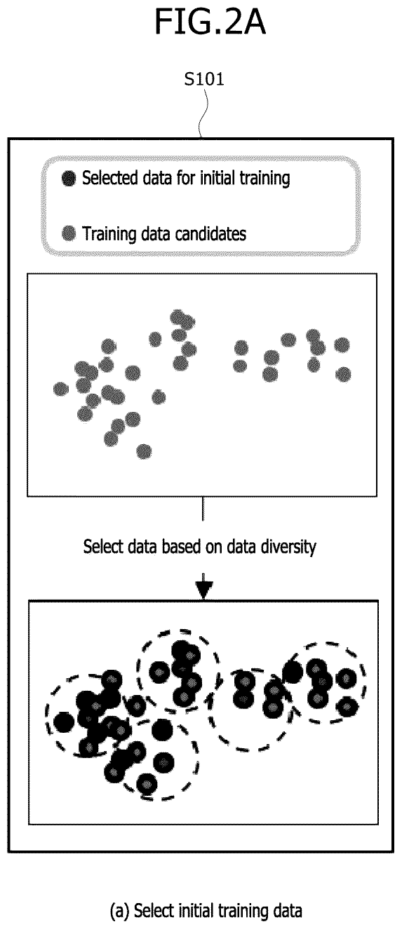

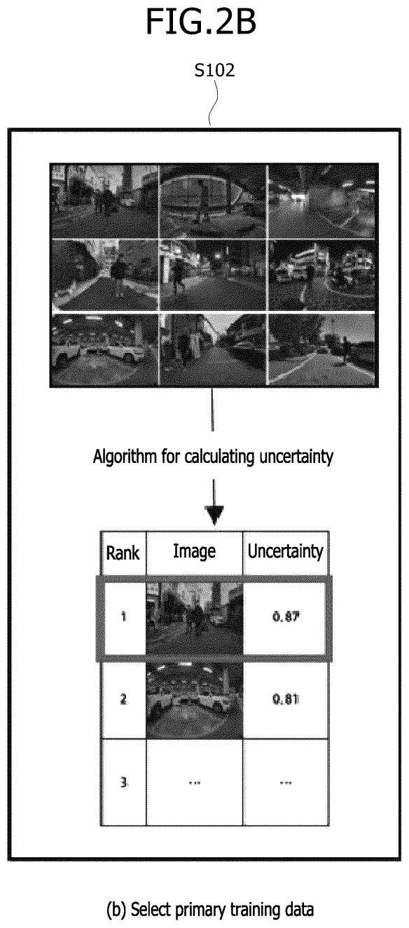

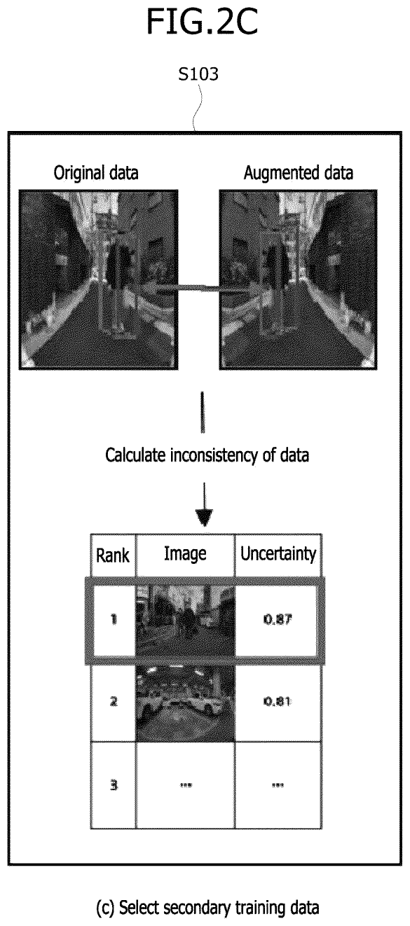

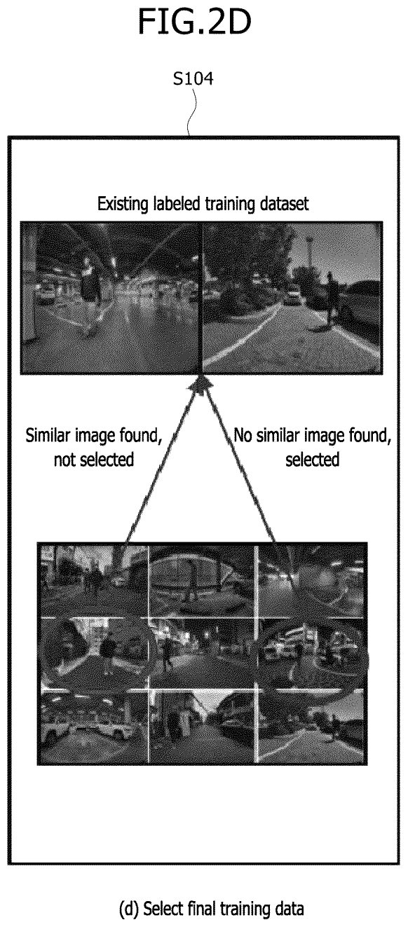

FIG. 1 is an exemplary diagram illustrating a schematic configuration of a device for selecting training data for 3D object recognition according to an embodiment of the present disclosure. FIG. 2A-FIG. 2D are exemplary diagrams illustrating a method for sequential selection of a dataset by a first to third processors in FIG. 1. Hereinafter, a method for selecting training data according to the present embodiment will be described with reference to FIG. 1 and FIG. 2A-FIG. 2D.

As illustrated in FIG. 1, a device for selecting training data for 3D object recognition according to the present embodiment includes a first processor 110 configured to select (filter) an initial training dataset from the original dataset based on diversity, a second processor 120 configured to select a highly useful training dataset from the initial training dataset selected (filtered) by the first processor 110 based on informativeness, and a third processor 130 configured to sort the training data selected (filtered) by the second processor 120, calculate the diversity relationships among the sorted training data, and select (filter) a final training data.

In this case, the first to third processors 110 to 130 may be integrated into a single processor.

The first processor 110 selects (filters) an initial dataset with evenly distributed data from the original dataset based on diversity (S101).

The first processor 110, as illustrated in step S101, selects representative data for each cluster (i.e., groups of similar data) based on the K-means clustering algorithm.

In other words, data for an initial training dataset is selected based solely on diversity without considering informativeness. Since a deep learning model has not been trained yet, informativeness cannot be calculated. Therefore, data for initial training is selected (filtered) based on diversity.

In step S101, each point corresponds to a single image. When the similarities between images are represented on a two-dimensional plane (or an n-dimensional plane or n-dimensional space), data within a close distance are grouped together inside a circle indicated by a dashed line.

In this way, the data at the center of each clustered data group may be selected. Such data at the center of the cluster (e.g., the data marked in red) may be considered representative of the group and selected as initial training data. The remaining data may be considered as data that is not selected as the initial training data.

The second processor 120 performs primary data selection from the initial training dataset selected (filtered) by the first processor 110, followed by secondary data selection (S102, S103).

In this case, the algorithms for primary data selection and secondary data selection perform data selection based on informativeness.

In this case, the algorithm for primary data selection calculates the uncertainty of the data based on entropy, and the algorithm for secondary data selection calculates the inconsistency of the data.

For example, if the entropy of the data is high, this may indicate that the data has high informativeness. If the difference in inference results between the original and augmented data is large, this may indicate high inconsistency, and data with high inconsistency may indicate high informativeness.

Accordingly, the second processor 120 iteratively performs primary and secondary data selection n times (where n is a natural number) and selects data with high informativeness to generate a training dataset.

The third processor 130 sorts the training data of the training dataset selected (filtered) by the second processor 130, calculates the diversity relationships among the sorted training data, and selects the training data based on the calculated diversity relationships to generate the final training dataset (S104).

In this case, entropy is an indicator that represents the uncertainty of the data.

The reason for selecting data with high uncertainty in step S102 when selecting primary training data is that the deep learning model performs better when trained on data with high uncertainty.

For example, data that lies on the boundary of whether the deep learning model detects this data as a person or not may be considered data with high uncertainty, and data that may be clearly classified as either a person or background may be considered data with low uncertainty.

When selecting secondary training data in step S103, the augmented data refers to data obtained by horizontally flipping the original data.

In other words, if the deep learning model produces similar prediction results even when the data is flipped horizontally, this data may be considered to have low uncertainty.

For example, if the model accurately detects a person in the original data but fails to detect a person in the augmented data (i.e., the horizontally flipped data), this may be considered to have high uncertainty.

For example, the second processor 120 selects training data with high entropy from the initial training dataset (S102), converts the selected primary training data into augmented data (e.g., flipped data), and additionally selects secondary training data with high entropy (S103).

More specifically, in steps S102 and S103, the second processor 120 quantifies the uncertainty of the data to select data with high uncertainty (i.e., data showing a high value of quantified uncertainty).

In this case, the second processor 120 iteratively performs primary and secondary data selection n times (where n is a natural number) and selects data with high informativeness to generate a training dataset.

The third processor 130 calculates the similarities between secondary training data, excludes data with a similarity higher than a threshold, and selects and labels only the remaining data as the final training data (S104).

Accordingly, through step S104, the third processor 130 excludes redundantly similar data to the greatest extent possible and selects only data that is as much dissimilar data as possible to generate the final training dataset, thereby increasing the usefulness (validity) of the training.

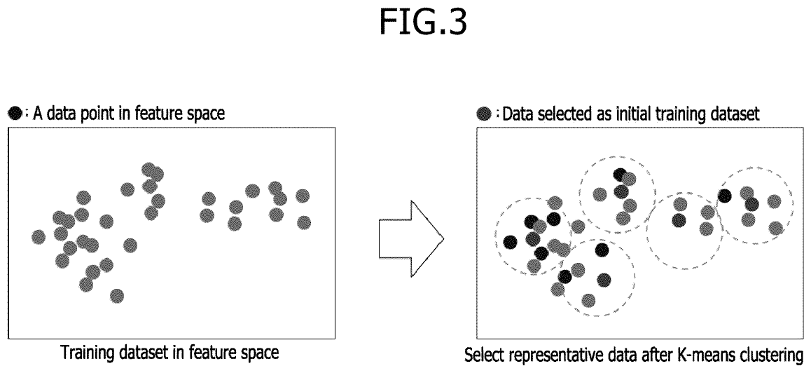

FIG. 3 is an exemplary diagram illustrating an operation of selecting initial training data by the first processor in FIG. 2A-FIG. 2D.

Referring to FIG. 3, each point represents features obtained when the data is passed through the deep learning module, shown in a feature space. The first processor 110 selects data through K-means clustering to generate the initial training dataset.

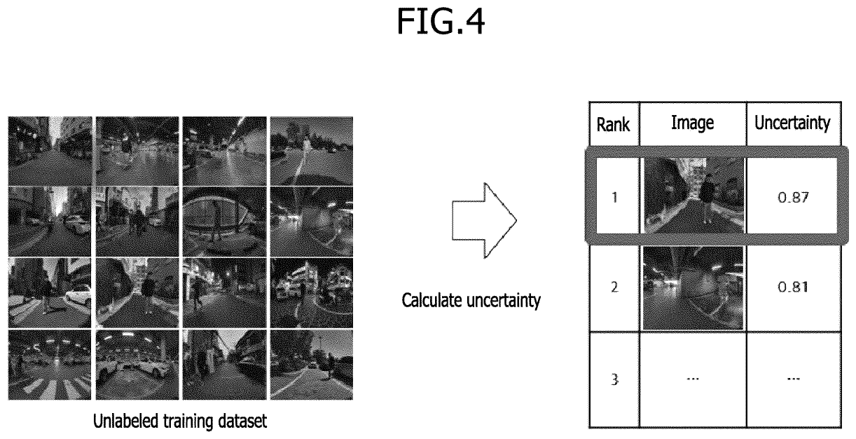

FIG. 4 is an exemplary diagram illustrating an operation of selecting primary training data by the second processor in FIG. 2A-FIG. 2D.

Referring to FIG. 4, the second processor 120 calculates the entropy of the data in the initial training dataset (an unlabeled training dataset) and finally calculates the uncertainty of the data based on this entropy. After calculating the uncertainty of each data point, the data is sorted in descending order, and the top k1 data points are selected.

For example, if there are 10,000 unlabeled training data points, the second processor 120 calculates the uncertainty of each data point and selects the data point with an uncertainty of 0.8 or higher (k1 data points).

More specifically, the second processor 120 iterates steps S102 and S103 n times. For example, if 10,000 data points need to be selected, approximately 20,000 data points are primarily selected in a single iteration. Through n iterations, data with low uncertainty are excluded from these 20,000 data points, thus finally selecting the 10,000 data points.

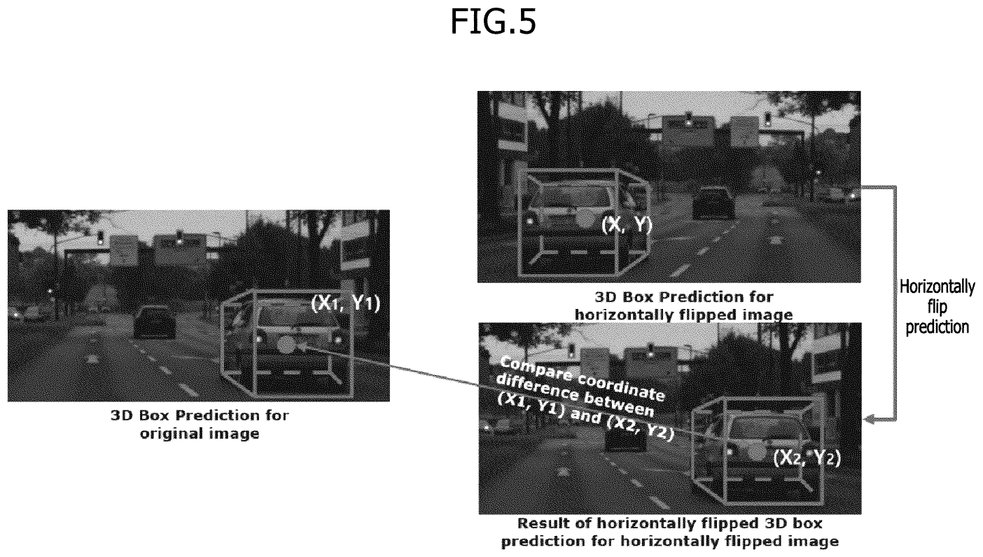

FIG. 5 is an exemplary diagram illustrating an operation of selecting secondary training data by the second processor in FIG. 2A-FIG. 2D.

Referring to FIG. 5, the second processor 120 generates augmented data by horizontally flipping primary training data. That is, the second processor 120 selects training data with high entropy as primary training data from the initial training dataset (S102), converts the selected primary training data into augmented data (e.g., flipped data), and additionally selects secondary training data with high entropy (S103).

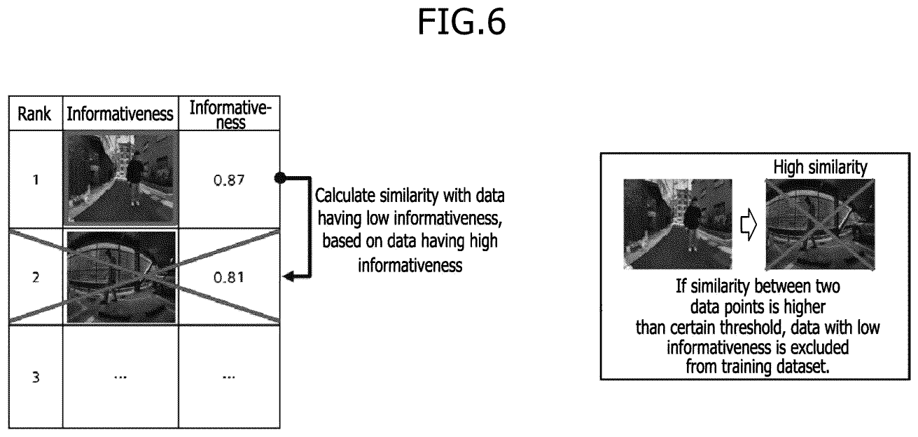

FIG. 6 is an exemplary diagram illustrating an operation of selecting final training data by the third processor in FIG. 2A-FIG. 2D.

Referring to FIG. 6, the third processor 130 calculates the similarity between the newly selected dataset (secondary training data) and the previously selected dataset (secondary training data), excludes data with a similarity higher than a threshold, and selects and labels the remaining data as the final training data.

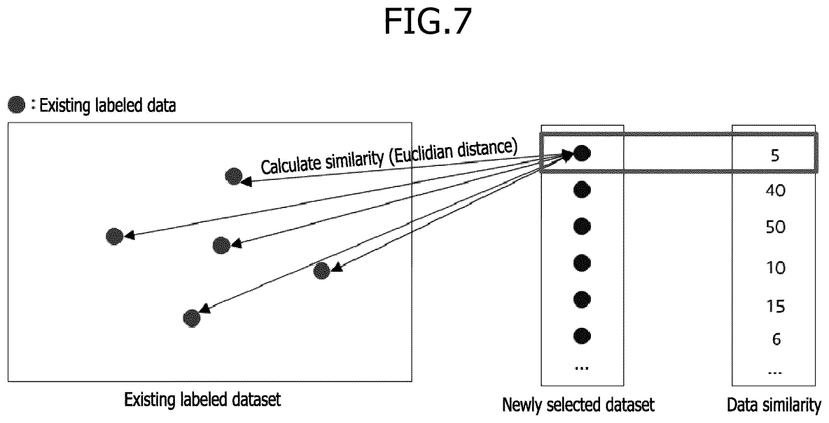

For reference, FIG. 7 is an exemplary diagram illustrating an algorithm for calculating the similarity between newly selected data and previously selected data in FIG. 6.

Referring to FIG. 7, the similarity may be calculated using the Euclidean distance algorithm. If a calculated distance is too close, this indicates that the newly selected data is similar to the previously selected data. Therefore, only data with a distance greater than a threshold may be selected as the final data.

However, the similarity calculation algorithm described above is exemplary and is not intended to limit the scope.

As described above, in the embodiment, it is possible to select training data to achieve optimal learning performance for 3D object recognition with a minimal amount of training data.

In the embodiment, it is possible to select training data by considering both informativeness and diversity, thereby achieving optimal learning performance for 3D object recognition with a minimal amount of training data.

In the embodiment, it is possible to achieve optimal learning performance with a small amount of data, thereby reducing data processing costs. By considering both informativeness and diversity of data in data selection, the advantages of each metric are maximized through the interaction between informativeness and diversity.

In addition, in the embodiment, it is possible to select datasets collected in environments different from that of the existing dataset (i.e., datasets with low similarity) by considering the diversity between the existing labeled dataset and the newly selected dataset.

What is claimed is:

1. A device for selecting training data for 3D object recognition, the device comprising:
a first processor configured to select initial training data based on diversity from an original dataset;
a second processor configured to select training data based on informativeness from the initial training data selected by the first processor; and
a third processor configured to calculate diversity relationships among the training data selected by the second processor and remove redundant data from the training data selected by the second processor based on the calculated diversity relationships and to select final training data.

2. The device of claim 1, wherein the first to third processors enable integration into a single processor.

3. The device of claim 1, wherein the first processor selects representative data for each cluster based on a K-means clustering algorithm to generate an initial training dataset.

4. The device of claim 1, wherein the second processor iterates a process of performing primary data selection from the initial training data, followed by secondary data selection, a specified number of times.

5. The device of claim 4, wherein the second processor performs the primary data selection using an algorithm that calculates uncertainty of data based on entropy and performs the secondary data selection using an algorithm that calculates inconsistency of data.

6. The device of claim 4, wherein the second processor generates augmented data by horizontally flipping original data when selecting secondary training data and selects data with high entropy from the augmented data.

7. The device of claim 4, wherein the second processor quantifies uncertainty of data when selecting primary and secondary training data, sorts the data in descending order, and selects highly ranked data with high quantified values.

8. The device of claim 1, wherein the third processor calculates similarities between secondary training data, excludes data with a similarity higher than a threshold, and selects only data with low similarity as the final training data.

9. The device of claim 8, wherein the third processor calculates the similarity between data using a Euclidean distance algorithm and selects only data with a calculated distance greater than a threshold as the final data.

10. A method for selecting training data for 3D object recognition, the method comprising:
selecting initial training data, by a first processor, based on diversity from an original dataset;
selecting training data, by a second processor, based on informativeness from the initial training data selected by the first processor; and
calculating diversity relationships, by a third processor, among the training data selected by the second processor, removing redundant data from the training data selected by the second processor based on the calculated diversity relationships and selecting final training data.
